(19) United States
(12) Patent Application Publication
(10) Pub. No.: US 2012/0134239 A1
(43) Pub. Date: May 31, 2012

(54) MICRO SONIC TRANSMITTER

(76) Inventor: Sheldon L. STRUTHERS, Blaine, MN (US)

(21) Appl. No.: 13/304,892

(22) Filed: Nov. 28, 2011

Related U.S. Application Data
(60) Provisional application No. 61/417,451, filed on Nov. 28, 2010.

(51) Int. Cl. H04B 1/02

(52) U.S. Cl. 367/137

(57) ABSTRACT

The present disclosure is directed to a transmitter having a minimal size and weight with acceptable output and life performance. The transmitter may be powered by a single 1.5V battery, rather than two 1.5V batteries in series, by electrically connecting a capacitor and voltage inverter to the microcontroller. The transformer to power the transmitter's ultra-sonic piezo transducer can be eliminated by the inclusion of an inductor selected to cause a resonance matched condition. A capacitor can be placed in parallel with the transducer to match the impedance to the inductor. The transmitter may have a power output of +156 dB (re: 1 uPa @ 1 meter), and certain physical properties, including a volume of 115 mm³; a dry weight of 280 mg; and an activated life (@ 5 sec PRI) of 35 days and an activated life (@ 3 sec PRI) of 23 days.

### PRIORITY

This application claims the benefit of priority based on U.S. Provisional Application Ser. No. 61/417,451 filed on Nov. 28, 2010, which is hereby incorporated by reference in its entirety.

### FIELD

The present invention relates generally to tracking systems. More particularly, the present invention relates to miniaturized transmitters for tracking systems that can be implanted in animals.

### BACKGROUND

Tracking the movement of targets is desirable in a variety of applications. One such application is the tracking of animals. There are many reasons why it is desirable to track animals, such as to understand their migrations, habitats, health and impact of environmental changes on their health so that future sustainability can be evaluated.

One application of animal tracking for research purposes is the Juvenile Salmon Acoustic Telemetry System (JSATS) program run by the U.S. Department of Energy. Detailed information about JSTAS can be obtained from the website http://jstas.pnl.gov/Default.aspx.

In summary, JSATS employs acoustic transmitters and receiving systems to remotely track fish in one, two, or three dimensions. JSATS uses acoustic transmitters small enough for implantation in the smallest migratory individuals of the juvenile Chinook salmon and steelhead populations of the Columbia River basin to monitor the behavior, movement, habitat use, and survival of juvenile salmonids migrating from freshwater (through rivers, reservoirs, and past hydroelectric dams) into saltwater. The JSATS system is also applicable to a wide range of aquatic species. For example, JSATS has been used to monitor the behavior of channel catfish, smallmouth bass, northern pikeminnow, walleye, and lamprey.

Using the data collected from the JSATS system, various useful studies can be performed, including:
Estimation of survival and travel time of juvenile salmon migrating more than 800 km of freshwater river, reservoir, estuary, and marine habitat;
Assessment of survival and habitat use of juvenile salmonids migrating through an estuarine environment;
Determination of impacts of ferry terminals on juvenile salmonid movements in salt water;
Estimation of route-specific dam passage survival of juvenile salmonids;
Observation of predator-prey interactions;
Evaluation of fish guidance and passage structures at hydroelectric dams using detailed 3D tracking; and
Monitoring of delayed mortality of juvenile salmonids transported past hydroelectric dams in barges.

The JSATS acoustic transmitters contain a transducer that intermittently produces signals by inducing high-frequency (416.7-kHz) vibrations in the water. These vibrations, or signals, are received by a stationary or mobile hydrophone submerged in the water. The vibrations are converted to electrical impulses that are sent to the receiver, which identifies the signals as a unique tag code and stores them to memory along with the hydrophone identification, time and date of detection, and environmental variables such as pressure and temperature. Data from a single stationary hydrophone allow researchers to determine if and when a specific individual fish passed the hydrophone location. Multiple stationary hydrophones arranged along transects (e.g., across a river channel) are referred to as arrays; the arrays detect whether or not a tagged individual passes a specific site. These types of arrays are commonly used in large rivers, lakes, reservoirs, and estuary and near-shore ocean environments. Three-dimensional hydrophone arrays can be deployed to not only detect the presence or absence of a tagged individual but also provide three-dimensional vectors (range, bearing, and depth) of the individual's movement. Three-dimensional arrays are frequently used around dams to assess route-specific dam passage behavior. In addition, real-time, three-dimensional movement vectors can be obtained by tracking tagged individuals with a vessel-mounted hydrophone, referred to as mobile tracking—a useful tool for monitoring tagged individuals in lakes, reservoirs, or between stationary arrays in large rivers or estuaries.

Conventional JSATS transmitter's are encapsulated in an epoxy resin and outer Parylene coating and consists of two silver oxide batteries, a circuit board, and the transducer.

Transmitters are activated by sending a coded signal to the transmitter via a “pinger dish.” Once activated, the transmitter emits a uniquely coded 31-bit binary phase-shift keyed signal, which provides more than 65,000 individual tag codes. The signal is emitted at a frequency of 416.7 kHz and at a source level of approximately 156 dB (relative to 1 gascal and 1 m). The length of time between signals is determined by the user-defined, pre-programmed PRI. Pulsing signals use less energy, which increases the life of the transmitter compared to continuous signals.

Conventional JSATS transmitters are available in a variety of sizes, weights, and pulse rate intervals (PRIs) to accommodate a range of fish sizes, study durations, and study objectives. The smallest conventional transmitter capable of meeting the specified power output (not less than +153 dB (re: 1 μPa @ 1 meter)) and minimum run times in solicitation number W9127N-10-R-0038 (3 second PRI: 20 days, 5 second PRI: 30 days, 7 second PRI: 40 days and 10 second PRI: 60 days), according to http://jsats.pnl.gov/SystenComponents/AcousticTransmitters.aspx, measures 12 mm long×5 mm wide×4 mm high, weighs 0.43 g (in air), and has an estimated tag life of 20-84 days (depending on the PRI; See Table 1 below). The largest, longest-lasting transmitter weighs 1.1-1.2 g and has an estimated tag life of 237-330 days. Transmitters used in 2008 were manufactured by Advanced Telemetry Systems.

TABLE 1
Specifications of 2008 JSATS acoustic transmitters.

| Dimensions | Weight in air | PRI | Estimated tag life |
|---|---|---|---|
| (mm) (L × W × H) | (g) | (s) | (d) |
| 12 × 5 × 4 | 0.43 | 3 | 20 |
| | | 5 | 32 |
| | | 10 | 84 |
| 13 × 6 × 4 | 0.55-0.60 | 7 | 95 |
| | | 10 | 121 |
| 13 × 6 × 7 | 0.83 | 7 | 127 |
| | | 10 | 161 |
| 14 × 7 × 7 | 1.00 | 7 | 190 |
| | | 10 | 242 |
| 18 × 8 × 7 | 1.10-1.20 | 7 | 237 |
| | | 10 | 330 |

There is a continuing desire to reduce the size and/or weight of the transmitter, while maintaining or improving the desirable output and/or life characteristics.

### SUMMARY

The disclosed invention provides for a transmitter having a reduced size that meets or exceeds the output and life characteristics of conventional transmitters described above. According to one aspect of the invention, the transmitter is powered by a single 1.5V battery rather than two 1.5V batteries in series as has been previously required in the conventional transmitters. According to another aspect of the invention, the previously required transformer needed to power the transmitter's ultra-sonic piezo transducer has been eliminated. According to a further aspect of the invention, transmitter components are maintained inside of an enclosed housing having a volume of less than 115 mm². In yet a further aspect of the invention, the transmitter has a dry weight of approximately 280 mg (for Flex PC boards) or 300 mg (for rigid PC boards). Any one or more of these aspects provide for a lighter and smaller transmitter while meeting or exceeding output power and transmitter life requirements. For example, a transmitter according to certain aspects of the invention has an activated life (@ 5 sec PRI) of at least 35 days. An activated life (@ 3 sec PRI) of at least 23 days is also achieved. Further aspects, features and advantages of the present invention will be apparent from the disclosure, including drawings, herein.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a top view and

FIG. 2 is a side view of a transmitter according to an example embodiment showing some of the components therein.

FIG. 3 is a top view and

FIG. 4 is a side view of a transmitter according to an example embodiment showing some of the components therein.

FIG. 5 is an electrical schematic of a transmitter according an example embodiment.

FIG. 6 is a top view partial assembly drawing of a transmitter according to an example embodiment.

FIG. 7 is a bottom view partial assembly drawing of a transmitter according to an example embodiment.

FIG. 8 is a drill drawing of a transmitter according to an example embodiment.

FIG. 9 is an electrical schematic of a transmitter according an example embodiment.

FIG. 10 is a top view partial assembly drawing of a transmitter according to an example embodiment.

FIG. 11 is a bottom view partial assembly drawing of a transmitter according to an example embodiment.

FIG. 12 is a drill drawing of a transmitter according to an example embodiment.

### DETAILED DESCRIPTION

In the following descriptions, the present invention will be explained with reference to various example embodiments; nevertheless, these example embodiments are not intended to limit the present invention to any specific example, embodiment, environment, application, or particular implementation described herein. Therefore, descriptions of these example embodiments are only provided for purpose of illustration rather than to limit the present invention. The invention is to cover all modifications, equivalents, and alternatives falling within the scope of the invention as defined by the appended claims

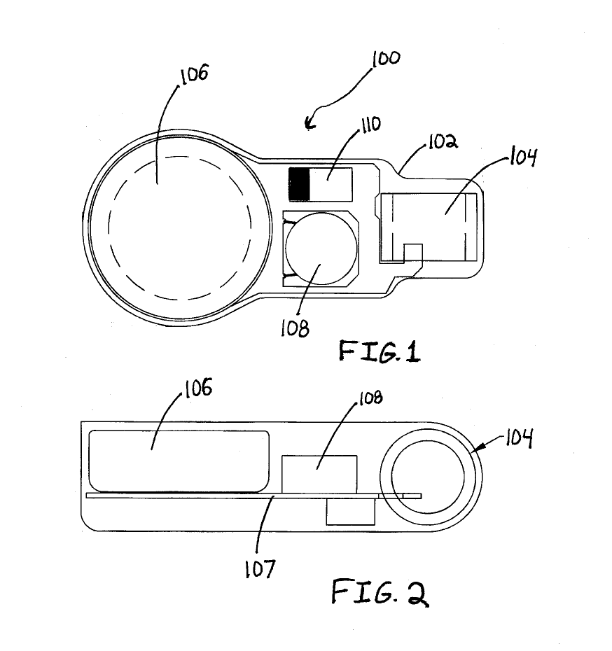

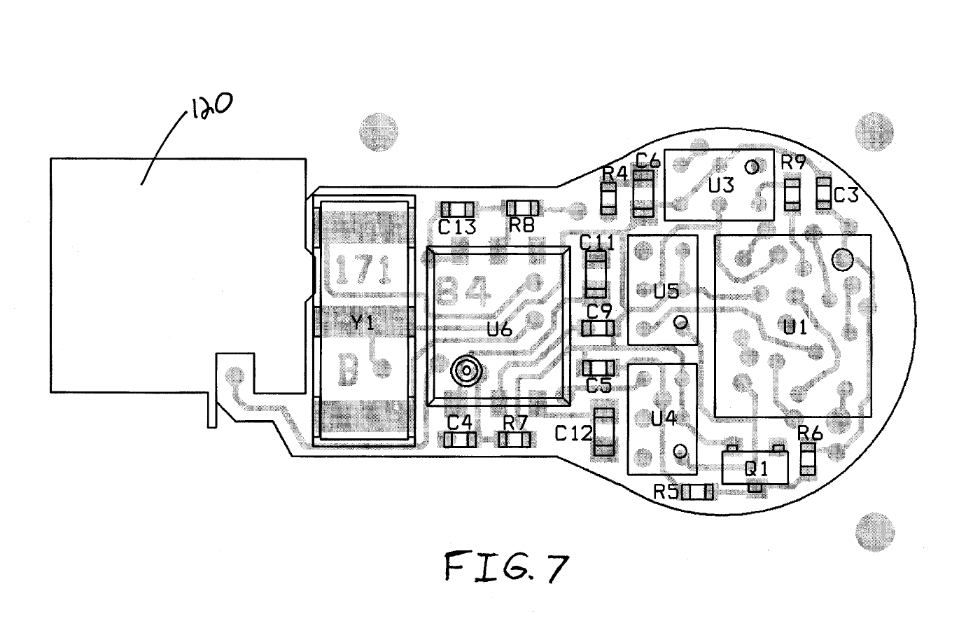

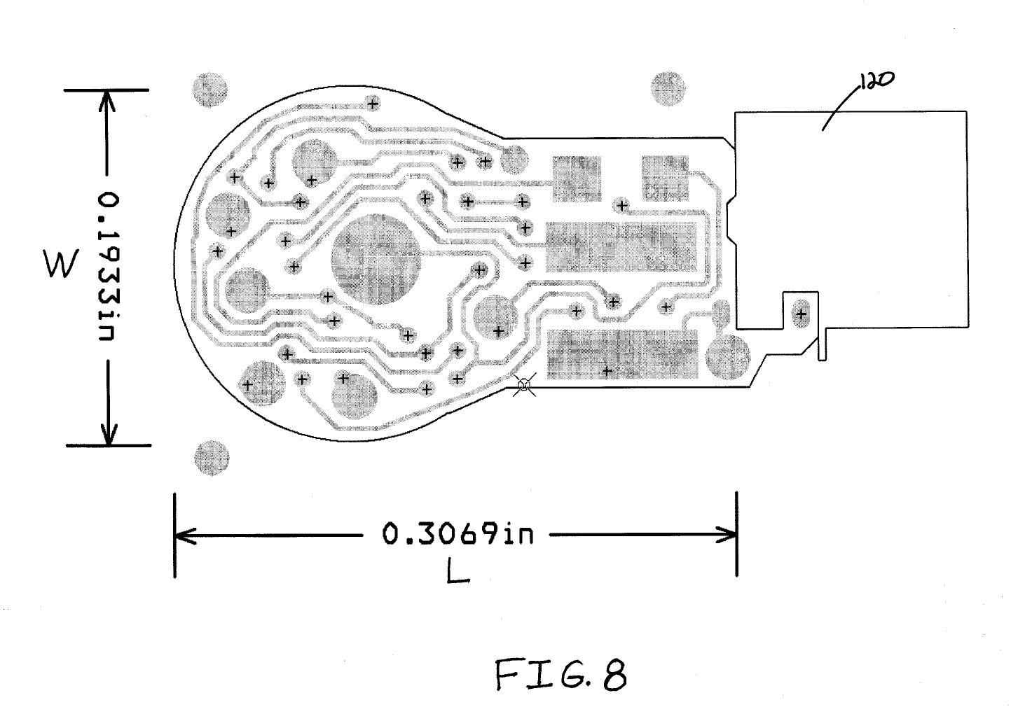

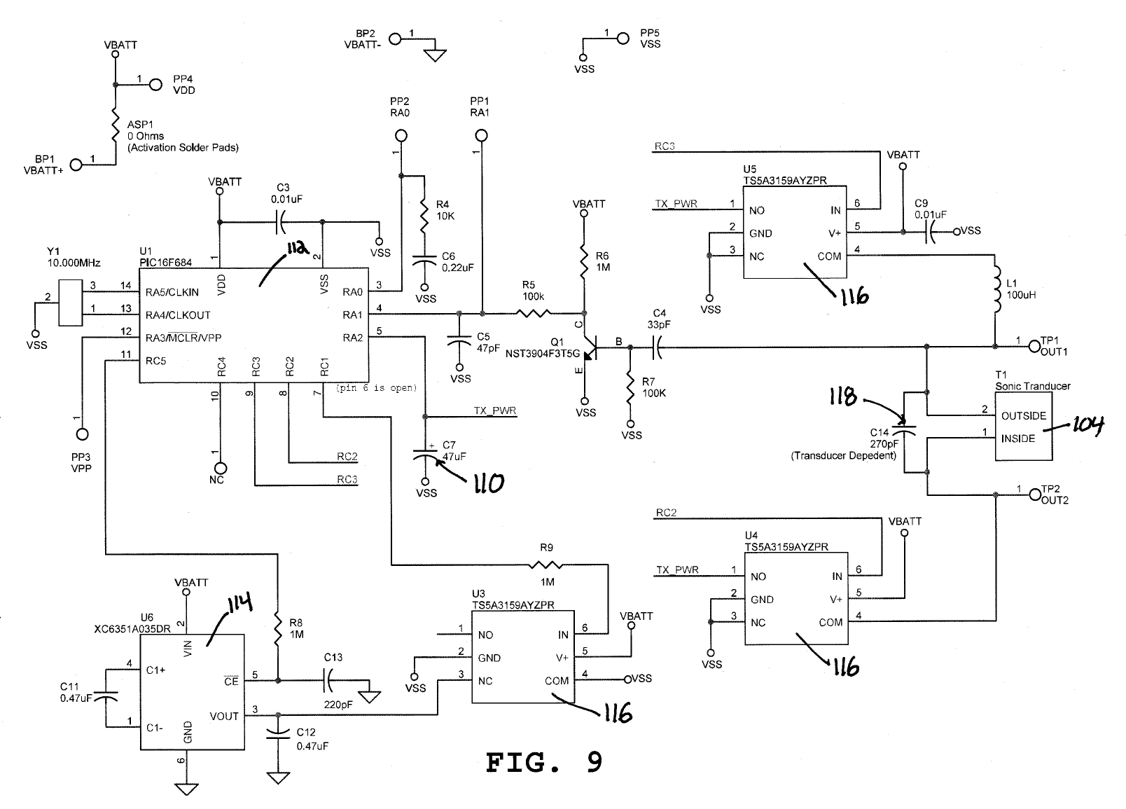

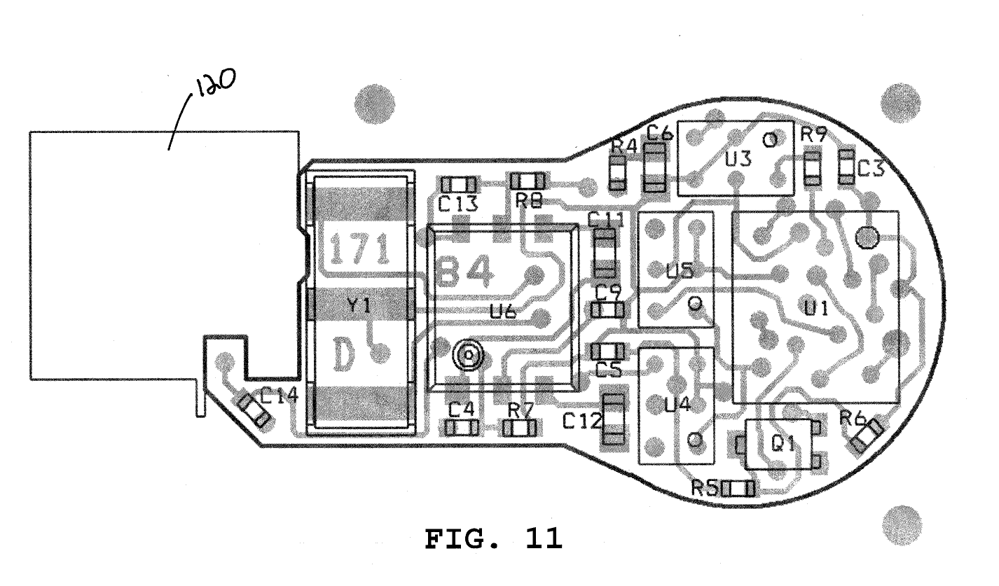

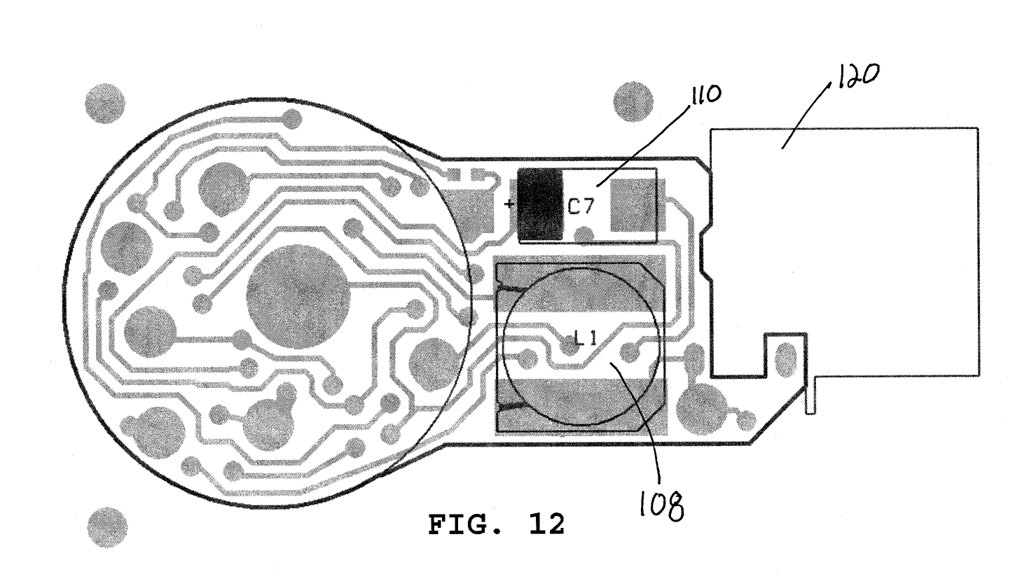

Referring to FIGS. 1-2, the transmitter 100 comprises a case 102 defining an interior volume. Disposed within the interior volume is a transducer 104 electrically connected to a battery 106 and certain electrical components on a circuit board 107. Further details on the board components and their connectivity will be described below and in the appended FIGS. 1-12.

The transducer 104 is a ceramic resonator (see Table 2 below) that generates a sonic or ultra-sonic wave, for example 416.7 kHz±0.5%. However, other outputs are within the scope of the invention. The transducer can have a power output of more than 153 dB (re: 1 uPa @ 1 meter). In one embodiment, the power output is +156 dB (re: 1 uPa @ 1 meter). However, other power outputs are within the scope of the invention. The battery 106 is a button-style 1.5V battery, such as a 337-type. However other types of batteries can be used without departing from the scope of the invention.

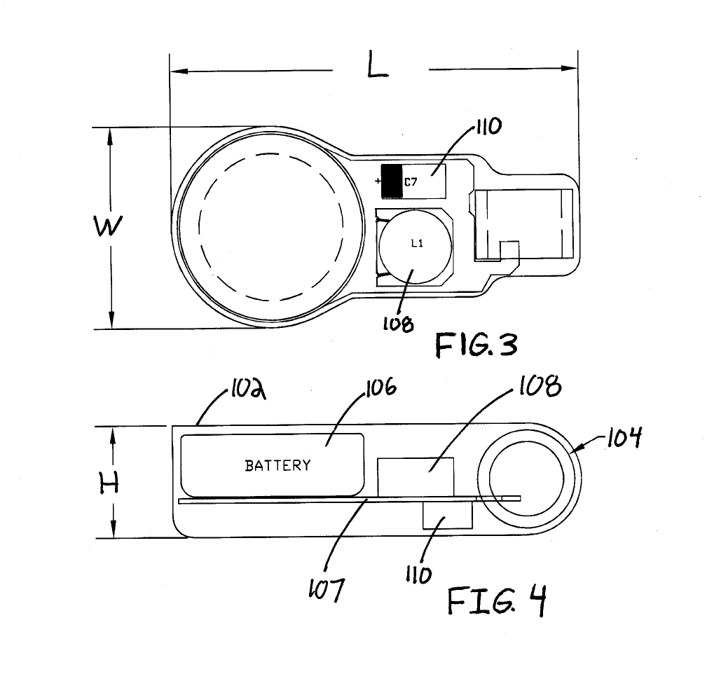

The housing or case 102 can take various shapes and sizes according to the scope of the invention. However, it is preferred that the dimensions do not exceed the following: width: 6.00 mm; height: 4.10 mm; length: 12.00 mm; volume: 300 mm³; and dry weight 430 mg. In a further preferred embodiment depicted in FIGS. 3-4, the transmitter has a length L of 10.7 mm; a width W of 5.0 mm; a height H of 2.8 mm; a volume of 115 mm³; and a dry weight of 280 mg. The transmitter of the present invention can achieve the above-noted power output, while having the latter dimensions and weight, while still achieving a life rating of 35 days at 5 seconds PRI or 23 days at 3 seconds PRI.

A lighter dry weight of 230 mg can also be achieved at the same output and dimensions when using a thinner battery (e.g., SR410SW from SONY). However, this lighter embodiment achieves only an 18 day life at 5 seconds PRI.

The housing can comprise a variety of materials, for example, plastics or an epoxy resin, and receive optional coatings, such as Parylene-C (or equivalent) to a minimum thickness of 25 microns. It is preferred that the housing be smooth and devoid of sharp edges or protrusions in order to promote implantability in the target.

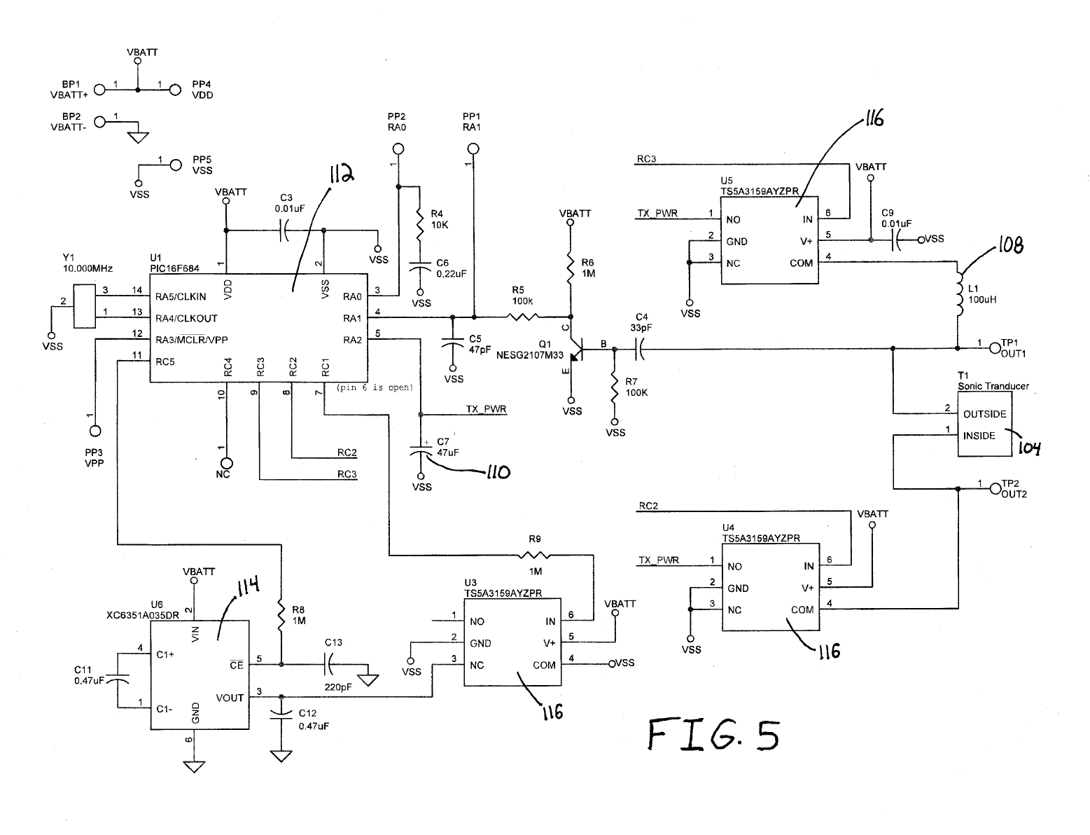

Referring to FIGS. 1-5 generally, and FIG. 5 in particular, various board components are shown. These components are not limited to any specific supplier, type, size, location or connectivity unless specifically stated in the appended claims. The figures, however depict one example embodiment configured to permit the transmitter to meet the size, weight and volume specifications of FIGS. 3-4, as discussed above. The following parts table (Table 2) corresponds to the components depicted in FIG. 5.

TABLE 2
Example Component Specifications.

| Qty. | Part Reference | Description |
|---|---|---|
| 2 | C3 C9 | Capacitor 01005 Size X5R 6.3 V 10000 pF +/− 10% |
| 1 | C4 | Capacitor 01005 Size COG, NPO 16 V 33 pF +/− 5% |
| 1 | C5 | Capacitor 01005 Size COG, NPO 16 V 47 pF +/− 5% |
| 1 | C6 | Capacitor 201 Size X5R 6.3 V 0.22 uF +/− 20% |
| 1 | C7 | CAP TANT 47UF 4 V LOPRO SMD |
| 2 | C11 C12 | Capacitor 0201 Size X5R 4 V 0.47 uF +/− 20% |
| 1 | C13 | Capacitor 01005 Size X5R 10 V 220 pF +/− 10% |
| 1 | L1 | Inductor 100 uH SMT Power Coilcraft D02010-104MLB |
| 1 | Q1 | Transistor NPN High Gain NESG2107M33 or NST3904F3T5G |
| | | 40 V 0.2 A SOT 1123 |
| 1 | R4 | Resistor 01005 Size Thick Film, 5%, 10K Ohm |
| 2 | R5 R7 | Resistor 01005 Size Thick Film, 5% 100K Ohm |
| 3 | R6 R8 R9 | Resistor 01005 Size Thick Film, 5% 1M Ohm |
| 1 | U1 | Microprocessor PIC16F684WD03 with RDL Solder Bump |
| 3 | U3 U4 U5 | IC Switch SPDT 6DSBGA TI TS5A3159AYZPR |
| 1 | U6 | IC Volt. Inv. U5P-6B Torex XC6351A035DR |
| 1 | Y1 | Ceramic Resonator 10.000 MHz Murata CSTCE10M0G55R0 |

Operation of the transmitter 100 is controlled by a microcontroller 112 (which includes flash memory, allowing post-encapsulation configuration of tag specific parameters) programmed with the desired functionality of the particular application. The microcontroller 112 is electrically connected to a voltage inverter 114, a plurality of switches 116, a capacitor 110, an inductor 108, the transducer 104 and the battery 106. Alternatively, a custom ROM-based component or an ASIC running at 1.5V or 3.0V could be utilized in place of the microcontroller. However, the microcontroller is preferred because it permits easy access to flash memory, permits firmware upgrades during assembly, permits tag specific parameters (e.g. ID and PRI) to be modified after assembly, and a “off the shelf” microcontroller can be used.

The microcontroller 112 requires a 3V supply. In the prior art transmitters, the 3V is supplied by two 1.5V batteries connected in series. However, the use of two batteries adds considerable weight, cost, size and volume to the transmitter as is apparent when comparing the specifications of convention transmitters to the transmitter depicted in FIGS. 3-4. The present invention eliminates the need for the second battery by employing a small, low-power voltage inverter 114 as part of a charge-pump inverter circuit that generates −1.5V from the +1.5V supply, thereby making 3V available to the microprocessor. The inverter circuit thus permits the 3V system microcontroller 112 to operate on only a single 1.5V battery. Therefore, the transmitter size, weight and volume can be greatly reduced since the battery is the largest and heaviest component in the device.

The transmitter must be capable of an acceptable operating life and shelf life. For example, in the JSATS application, the desired minimum activated transmitter life based on commonly used pulse rate intervals (PRIs) are: 3 second: 20 days, 5 second: 30 days, 7 second: 40 days, and 10 second: 60 days. In addition, the inactive transmitter should maintain greater than 85% of battery capacity for 12 months after the date of manufacture when stored at room temperature. It is contemplated within the scope of the invention that longer and shorter life values may be applicable.

Despite the fact that the voltage inverter 114 uses very little power, its quiescent current supply is still too large to meet the activated life expectancies noted above. Thus, in an additional aspect of the invention, the microcontroller 112 only periodically turns on the charge pump 114 as needed to charge storage capacitor 110. In the example of FIG. 5, the capacitor is 47 μF. However, the capacitance can be larger or smaller depending on the desired life performance of the particular application without departing from the scope of the invention. Since the microcontroller 112 generally does not use much power, the charged capacitor 110 is able to power the microcontroller system for extended periods of time while the charge-pump inverter 114 is disabled (not wasting any quiescent power). The particular example arrangement shown in FIG. 5, for example, has an expected activated life (@ 5 sec PRI) of 35 days and (@ 3 sec PRI) of 23 days.

In operation, on power-up, when the battery 106 is first connected to the board, the circuitry is configured to have the charge pump 114, normally controlled by the 3V microcontroller, turn “on” by default. This configuration allows the 3V microcontroller to start-up from the single 1.5V battery. Once the capacitor 110 is charged (3V), the microcontroller 112 is then free to disable the charge-pump inverter 114 (saving power), only turning it back on when it is necessary to, once again, quickly recharge the system capacitor 110 to 3V. Once the system is regularly transmitting pulses, the charge pump is only turned on just prior to the transmission of a pulse. The charge pump continues to operate during the transmitter pulse but once the pulse is complete, it is shut off by the microcontroller to save power. The charged capacitor is capable of powering the microcontroller system until the next transmitter pulse is needed even if the PRI (pulse rate interval) is at the maximum value of 10 seconds (and it even could go longer).

The present configuration is further advantageous over the prior transmitters because only one charge capacitor is needed. In the prior JSATS transmitters, the battery was not capable of supplying enough power for a transmitter pulse during the short interval of the pulse. To store enough energy a capacitor was required. The improved efficiency of the present invention only uses approximately ½ as much energy per pulse, so the needed capacitance is reduced. The charge capacitor is one of largest components of the transmitter. Previously, two 47 uF capacitors were used to store enough energy for the transmitter pulse. The single 47 uF capacitor of the present invention further reduces the size and weight of the transmitter (and reduces the manufacturing costs and improves the reliability of the system). Additional efficiencies are gained by the single capacitor due to reduced power drain because the leakage current of one capacitor is ½ of the conventional devices using two capacitors (saving further power).

Another aspect of the invention involves improving the efficiency of the transmitter output drive. In the prior art transmitter designs discussed in the Background section, a wire-wound transformer had been used to increase the peak-to-peak output voltage supplied to the system's transducer from 6 Vpp to roughly 20 Vpp. A large voltage across the transducer is necessary to overcome the inherent capacitance of the sonic transducer. The transformer is a relatively heavy component. The transformer also added considerable cost and complexity to the transmitter due to the part cost and the labor necessary to solder the part to the board in several separate nodes. The circuit of the transmitter disclosed herein omits the transformer, and instead, boosts the voltage to the transducer 104 by inserting an inductor 108 in series with the output to the ultra-sonic piezo transducer 104. This inductor value (100 uH in this example) is chosen to “cancel” most of the capacitance seen in the transducer 104. Said in another way, the inductance value is chosen so that the inductor 108 and capacitance of the transducer 104 are in resonance at the transmitter frequency. As a result, when driven with only +1-3V signals, this resonant circuit achieves a voltage across the transducer 104 which is slightly larger than the prior art transmitter using a transformer discussed in the Background section.

The elimination of the transformer and inclusion of an inductor discussed above and shown in the figures provides multiple advantages over the prior art. For example, weight is reduced. The inductor used in the example embodiment is much smaller and lighter than the transformer. The transmitter circuit is also much easier to assemble. The inductor is an “off-the-shelf” component, whereas the transformer was wound by hand and soldered by hand to the circuit board. Efficiency is also increased. The circuit using the inductor is significantly more efficient (using less than 50% of the energy of the old circuit) in delivering energy to the piezo transducer. The increased efficiency allows the transmitter according to the example embodiment of the present invention, with a single battery, to last as long as the prior art double battery device discussed in the Background section above. The increased efficiency also permits the output power of the transducer to be increased.

The transmitter can be activated from an off or dormant state in a variety of ways. A switch, such as a reed switch, may be included in the housing and electrically connected to the microcontroller. The reed switch advantageously allows the transmitter to be activated without the need for a physical switch. Physical switches could be unintentionally triggered and turn off the transmitter after implantation. Plus, physical switches often present undesirable protrusions or non-smooth portions on the exterior of the housing. Reed switches, however add size and cost to the transmitter.

An alternative to using a magnetic actuation means, such as a reed switch, is to utilize the peizo resonator of the transducer as a receiver. The transducer can be activated by applying a sufficiently strong emission at the resonant frequency. The emission can be pulsed to transmit encoded information to the microcontroller. These encoded control signals help reduce the possibility of noise causing a false command to be received by the system. When inactive or dormant, the microcontroller can thus listen for activation signals from the user being transmitted via the transducer. This communication scheme can also provide additional functional information to the microcontroller, including adjustment of operating characteristics. By using the transducer as the power or “on-off” switch, the overall packaging size, cost and weight can be minimized.

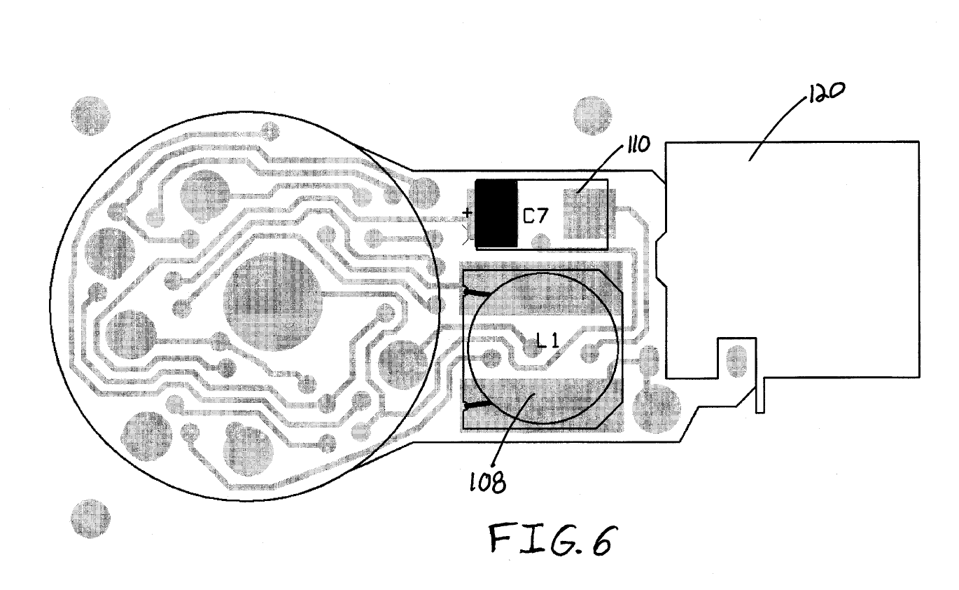

Referring to FIGS. 6-8, partial assembly drawings and a drill drawing for the circuit board 107 and various circuit components is shown. The reference numbers correspond to the parts indicated in Table 2 provided above. It should be noted, however, that the component layouts and connectivity can be varied without departing from the scope of the invention.

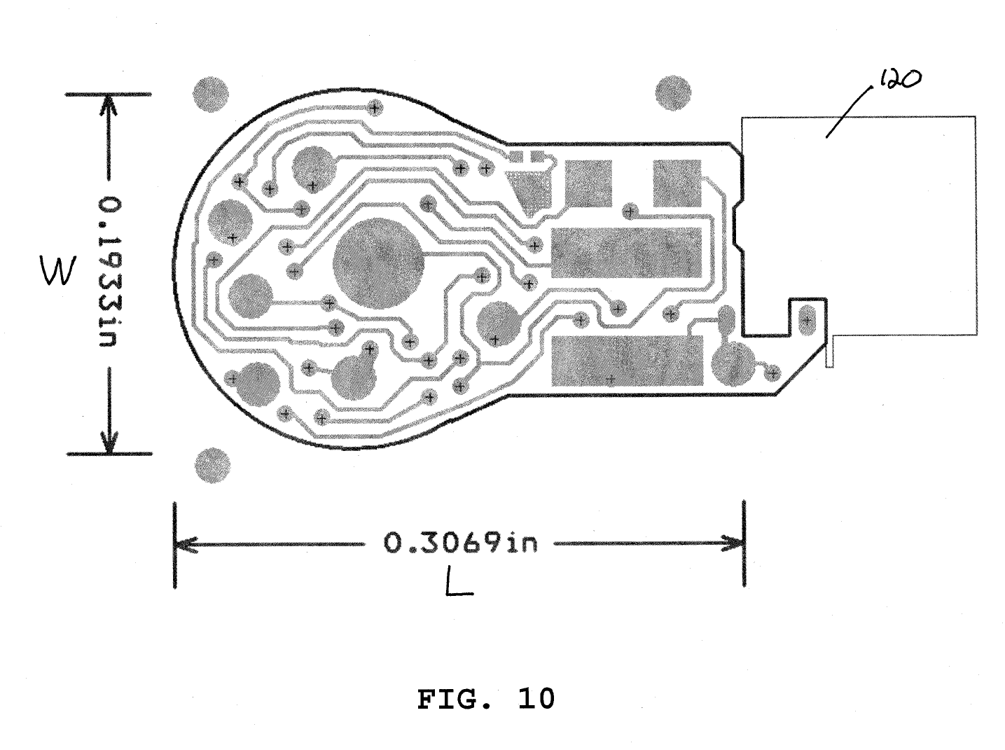

In yet a further aspect of the invention, the capacitance of the transducer can be adjusted to ensure that the inductor 108 and capacitance of the transducer 104 are in resonance at the transmitter frequency. Sometimes, the capacitance of a batch of transducer elements can vary considerably across members of the same batch or from batch to batch. Therefore, a small capacitor 118 (e.g., 270 pF) can be placed in parallel with the transducer 104 in order to match the impedance of the inductor 108. The capacitance of capacitor 118 is thus selected to accomplish this impedance matching. This small capacitor 118 is shown in the electrical schematic of FIG. 9 and the partial assembly drawings and a drill drawing of FIGS. 10-12. The reference numbers correspond to the parts indicated in Table 2 provided above, except that the added capacitor 118 is item C14, which is Capacitor 01005 Size X5R 10V 270 pF+/−10%.

The manufacture of the board comprises several steps and/or aspects, including
Board Material can include FR4 or Flex.
Board Thickness: 0.008″ (FR4) or 0.003″ (Flex)
Board spacing/line width: 0.003″
This board has a laser cut out section 120 (cut out made during board fabrication)
Two layer board: Top/Bottom
Panenlize all layers (including fiducials): 3.1″ (vertical)×3.0″ (horizontal) array
   5×8 array of boards per panel is required (40 boards/panel)
   Vertical (5 boards): 0.500″/board, Horizontal (8 boards): 0.300″/board
   0.125″ tooling holes should be placed in the four corners of the panel:
0.1″ minimum distance center of tooling hole to edge of board
ii. 0.12″ minimum distance from edge of tooling hole to test pads
   ALL panelized files must be sent to customer (including Solder Paste layers)
Solder Mask Color: GRN, Type: Wet
Vias: conductor filled and covered with soldermask (‘vias in pads’ exist)
Eleven non-component test pads exist on the top layer where no space is left between copper/soldermask. These eleven pads are soldermask defined. (11=2 (oblong)+9 (round): do not cover these 11 gold test pads with solder)
Final Copper Plating Thickness: as required for 3 mil lines/spacing
Finish: 3-8 Micronlnches Immersion Gold over (max) 100-200 Microlnches Nickel
   It should be noted, however, that the aspects above may be altered, omitted or combined in various permutations without departing from the scope of the invention.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A transmitter, comprising
a housing defining an enclosed volume of not more than 115 mm³;
a piezoelectric transducer having a capacitance and being disposed within the housing and configured to emit an ultrasonic signal having a power of greater than 153 dB (re: 1 uPa @ 1 meter);
a microcontroller disposed within the housing and operably connected to the transducer;
a battery disposed within the housing and operably connected to the microcontroller;
a voltage inverter disposed within the housing and operably connected to the microcontroller and the battery;
a charge storage capacitor disposed within the housing and operably connected to the microcontroller; and
an inductor disposed in series with the transducer and having an inductance value that cancels the capacitance of the transducer.

2. The transmitter of claim 1, wherein no transformer for powering the transducer is included in the enclosed volume of the housing.

3. The transmitter of claim 1, comprising a life rating of at least 23 days at 3 seconds PRI.

4. The transmitter of claim 1, wherein the charge storage capacitor consists of a single capacitor having a capacitance of less than 50 uF.

5. The transmitter of claim 1, wherein the transducer is configured to receive a communication from outside of the enclosed volume in the form of sonic emissions at a resonant frequency of the transducer, and wherein a response to the communication is transmittable to the microcontroller.

6. The transmitter of claim 1, comprising a life rating of at least 35 days at 5 seconds PRI.

7. The transmitter of claim 1, comprising a dry weight of less than 300 mg.

8. The transmitter of claim 7, comprising a dry weight of less than 280 mg.

9. The transmitter of claim 1, wherein the capacitance of the transducer includes a capacitor electrically connected in parallel with the transducer.

10. The transmitter of claim 1, wherein the housing has a width of less than 6.00 mm, a height of less than 4.10 mm and a length of less than 12.00 mm.

11. The transmitter of claim 10, wherein the housing has a length of approximately 10.7 mm; a width of approximately 5.0 mm and a height of approximately 2.8 mm.

12. The transmitter of claim 1, comprising a life rating of at least 23 days at 3 seconds PRI;

13. The transmitter of claim 1, wherein the battery comprises a single 1.5 V battery cell.

14. The transmitter of claim 1, comprising a dry weight of 230 mg and a 18 day life at 5 seconds PRI.

15. A tracking device including a transducer that intermittently produces pulsed signals for tracking a target in which the tracking device is implanted, the device comprising:
a housing defining an enclosed volume of not more than 115 mm³, the housing having disposed within the enclosed volume:
a piezoelectric transducer disposed within the housing, the transducer configured to emit an ultrasonic signal greater having a power of greater than 153 dB (re: 1 uPa @ 1 meter);
a control device;
a battery
a voltage inverter
a charge storage capacitor; and
an inductor,
wherein the tracking device comprises a dry weight of less than 300 mg.

16. The tracking device of claim 15, having a life rating of at least 35 days at 5 seconds PRI.

17. The tracking device of claim 15, wherein the housing comprises a maximum length of 11.0 mm, a maximum width of 5.0 mm and a maximum height of 3.0 mm.

18. A method of tracking a target, comprising
providing a housing having an enclosed volume of not more than 115 mm³;
disposing within the enclosed volume
a piezoelectric transducer having a capacitance and being configured to put out an ultrasonic signal greater having a power of greater than 153 dB (re: 1 uPa @ 1 meter);
a controller configured to operate at a controller input voltage;
a battery having a battery output voltage;
a charge pump inverter configured to convert the battery output voltage into the controller input voltage; and
a charge storage capacitor; and
an inductor;
turning on the charge pump inverter periodically to charge the charge storage capacitor;
turning off the charge pump inverter when the charge storage capacitor is charged;
turning on the charge pump inverter during the transmission of a pulse;
turning off the charge pump inverter after the transmission of a pulse;
disposing an inductor in series with the transducer;
transmitting a high frequency pulse by the transducer without a transformer being disposed within the enclosed volume of the housing.

19. The method of claim 18, wherein the inductor comprises an inductance value cancelling out the capacitance of the transducer and any capacitor connected in parallel with the transducer.

20. The method of claim 18, wherein the inductor and the transducer are in resonance at a transmission frequency.
